(19) United States
(12) Patent Application Publication
(10) Pub. No.: US 2009/0153050 A1
(43) Pub. Date: Jun. 18, 2009

(54) PLASMA DISPLAY PANEL

(76) Inventors: Kazutaka Tsuji, Hachioji (JP); Ryo Inoue, Hitachinaka (JP); Shunsuke Mori, Kokubunji (JP); Masaaki Komatsu, Kodaira (JP); Tatsuya Miyake, Tokorozawa (JP); Keizo Suzuki, Kodaira (JP); Hideto Momose, Hitachiota (JP); Shirun Ho, Tokyo (JP)

Correspondence Address: MATTINGLY & MALUR, P.C., 1800 DIAGONAL ROAD, SUITE 370, ALEXANDRIA, VA, 22314, US

(21) Appl. No.: 12/335,561

(22) Filed: Dec. 16, 2008

(30) Foreign Application Priority Data
Dec. 17, 2007 (JP) 2007-324455

(51) Int. Cl. H01J 17/49

(52) U.S. Cl. 313/582

(57) ABSTRACT

A high-quality long-life plasma display panel is provided by enabling compatibility between priming-electron emission characteristics, and other characteristics such as sputtering resistance, secondary electron emission characteristics, and wall charge retention. The plasma display panel is structured to include a front substrate, transparent electrodes and bus electrodes provided on the inner side of the front substrate, a dielectric layer covering these electrodes, a first protective layer covering the dielectric layer, and a second protective layer disposed on the side closer to the discharge space than the first protective layer. The first protective layer is doped with Sc to generate a predetermined excitation light by incidence of ultraviolet light. The second protective layer is doped with Si to emit electrons to the discharge space by the excitation light. With this structure, it is possible to realize a plasma display device in which the discharge delay is small, thereby the fluctuation less occurs.

### CLAIM OF PRIORITY

The present application claims priority from Japanese Patent Application JP 2007-324455 filed on Dec. 17, 2007, the content of which is hereby incorporated by reference into this application.

### FIELD OF THE INVENTION

The present invention relates to a plasma display panel, and more specifically, to a structure and method for forming a high quality plasma display panel with excellent lifetime characteristics.

### BACKGROUND OF THE INVENTION

Plasma display devices have recently been put into practical use for large sized thin color display devices. Particularly, an ac surface-discharge type PDP is an ac-driven plasma display device for generating display discharge between electrodes provided on a single substrate, which is the most commonly used system due to its simple structure and high reliability. FIGS. 1 and 2 show the structure of a typical ac surface-discharge type PDP. FIG. 1 is an exploded perspective view of a front panel 12 and a back panel 13 disposed facing each other. FIG. 2 is a cross-sectional view of the structure of a unit discharge cell, showing two different sections of the same structure taken along the dashed lines in the figure. The xyz coordinate axes are common in FIGS. 1, 2.

The back panel 13 includes stripe-like address electrodes 10 formed on a back substrate 11, a dielectric layer 9 covering the address electrodes 10, barrier ribs 7 formed on the dielectric layer 9 to maintain discharge gaps and prevent crosstalk between adjacent cells, and phosphor layers 8 formed respectively between the barrier ribs 7 to emit red light, green light, and blue light. The front panel 12 includes display electrodes 6 each having stripe-like transparent electrodes 4a, 5a and bus electrodes 4b, 5b that are orthogonal to the address electrodes 10, a dielectric layer 2 covering the display electrodes 6, and a protective layer 3 formed on a surface of the dielectric layer 2. A discharge space 14 is formed between the front panel 12 and the back panel 13. The display electrode 6 is a pair of a scan electrode 4 and a sustaining electrode 5. Incidentally, this example shows a stripe-like structure for the barrier ribs 7, in which an intersection of a pair of display electrodes 6 and a pair of address electrodes 10 constitutes a unit discharge cell. However, the barrier ribs are often provided parallel to the display electrodes as well. In this case, the discharge space 14 is divided by vertical and horizontal barrier ribs to form unit discharge cells.

Here, the protective layer 3 is robust to ion bombardment by discharge and has better sputtering resistance than the dielectric layer 2. For this reason, the protective layer 3 has a function of preventing the dielectric layer 2 from being damaged by ion bombardment, thereby realizing a long-life plasma display panel.

Further, the protective layer 3 is formed from a material having a large secondary electron emission coefficient upon incidence of ions generated in the discharge space 14. This enables low voltage discharge, resulting in high luminance efficiency, reduced circuit costs, and prolonged lifetime.

In addition, the protective layer 3 is expected to have excellent priming-electron emission characteristics for address discharge. This enables the protective layer 3, in the address discharge for selecting pixels to perform display emission, to reduce the address discharge delay time (hereinafter also simply referred to as discharge delay time or discharge delay) from when address voltage is applied between the scan electrodes 4 and the address electrodes 10 to when discharge is generated, and to reduce the fluctuation thereof. As a result, it is possible to prevent erroneous display that generated by an address error.

As described above, the protective layer 3 has the three important functions: protection of the dielectric layer 2, secondary electron emission, and priming-electron emission. In addition to these functions, the protective layer 3 is also expected to have such characteristics as high resistance to retain wall charge, high transparency to visible light generated in the phosphor layers 8, and less sensitive to surface contamination occurred during the process. More specifically, the protective layer 3 typically has a structure in which, for example, a film mainly containing magnesium oxide (hereinafter referred to as MgO) is formed on the dielectric layer 2 to a thickness of 300 nm to 1000 nm.

MgO is an excellent material in terms of sputtering resistance and secondary electron emission characteristics. Moreover, there has been a strong demand for reducing address time, reflecting the recent trend of single scan to achieve high definition and low cost. In particular, the importance of priming-electron emission characteristics has increased. Several techniques have been proposed to increase the priming-electron emission function of the protective layer formed from the material mainly containing MgO. For example, Patent document 1 (Patent Application No. 3247632) describes a doping technique of Si, and Patent document 2 (JP-A No. 2006-207013) describes a doping technique of Sc. In order to improve the priming electron emission effect, temperature dependency, sputtering resistance, and voltage margin, for example, Patent document 3 (JP-A No. 2006-169636) or Patent document 4 (US 20060145614(A)) describes a co-doping technique for doping of two or more elements. Further, Patent document 5 (JP-A No. 2005-135828) describes a doping technique of these additive elements into MgO with a gradient formed therein. Still further, Patent document 6 (WO 2004/049375) describes a doping technique of different elements.

### SUMMARY OF THE INVENTION

In the conventional techniques described above, the protective layer of impurity-doped MgO is subjected to a predetermined doping into the area of the interfacial surface of the protective layer that emits electrons to the discharge space. That is, the effect is achieved by doping the whole surface area of the protective layer, for example, including a new surface exposed from the existing surface by sputtering. For this reason, in order to meet the demand for the protective layer in terms of the characteristics of the area of the interfacial surface, such as sputter resistance, secondary electron emission characteristics, and wall charge retention, in addition to the priming electron emission, the area of the interfacial surface of the protective layer must satisfy all conditions. However, for example, it may happen that the priming-electron emission characteristics and the other characteristics such as sputtering resistance and wall charge retention are not compatible with each other, resulting in a trade-off between them. This has made it difficult to reduce the discharge delay while satisfying total image quality and lifetime requirements.

To overcome the above problem, the following methods have been proposed. As described in Patent document 5, there is provided a structure in which MgO is embedded with a material that emits priming electrons to reduce erroneous display with a gradient formed therein, so that an electron emitting portion of the protective layer is constantly exposed to the discharge space even when the protective layer is sputtered. As described in Patent document 6, a material having different electron emission characteristics is dispersed into the protective layer, so that erroneous display is reduced by priming electrons emitted from the dispersed material. However, these structures are disadvantageous in that a part of the area having excellent priming-electron emission characteristics is exposed for each pixel. Thus, it is necessary to form the protect layer by a complex process including deposition using a fine mask, sandblast, and photolithography. This poses a problem of manufacturing costs and yields.

Another problem the present invention aims to solve is that co-doped materials are competing with each other, and not effectively acting on each other. Typically, the priming-electron emission characteristics are improved by doping, for example, Si into the protective layer of MgO. In this case, Si forms an electron trap at a shallow energy level from the conduction band in MgO. Electrons excited by ultraviolet light generated in the discharge space are captured by the shallow trap. Then, the electrons captured in the vicinity of the surface of the protective layer (at a depth of about 10 nm or less) are gradually emitted to the conduction band by thermal excitation. This could be involved in the priming-electron emission process, the so-called exoelectron emission. Here, it is assumed that an element other than Si is co-doped to form an electron trap of a different energy level from that of Si, in order to further improve, for example, the priming-electron emission characteristics and the temperature dependency. In this case, the electron trap of Si and the electron trap of the co-doped material compete with each other. The electrons excited by ultraviolet light in the vicinity of the surface of the protective layer are not effectively captured by the two traps because of their competition. Thus, there has been a problem that a sufficient co-doping effect is not obtained.

A first object of the present invention is to provide a plasma display panel capable of achieving both high quality and long life by excellent discharge characteristics, with a protective layer structure that enables compatibility between priming-electron emission characteristics, and other characteristics such as sputtering resistance, secondary electron emission characteristics, and wall charge retention, without using complex processes.

A second object of the present invention is to provide a high quality plasma display panel having high response characteristics in a wide temperature range and driving conditions, with a structure that is doped with non-competitive materials and thereby enables a material design in which the doping effect of each material is not damaged, in the application of co-doping technique to the protective layer for the purpose of improving the priming-electron emission characteristics.

The plasma display panel according to the present invention is formed from at least two or more protective layers having different properties. One of the protective layers, a first layer, which is disposed on the side close to the dielectric layer, has a property of emitting a specific excitation light (ultraviolet light and/or visible light) in the process of recombination of electrons generated by incidence of ultraviolet light generated in the discharge space. The other layer, a second protective layer, which is disposed on the side closer to the discharge space than the first protective layer, has a property of emitting electrons to the discharge space by excitation light generated in the first protective layer. As for the second protective layer, I it is possible to select a material having such characteristics as sputtering resistance, secondary electron emission characteristics, and wall charge retention, which are superior to those of the first protective layer. The specific means are as follows.

(1) There is provided a plasma display panel including: a front panel having plural electrodes, a dielectric layer on the electrodes, and a protective layer covering the dielectric layer; a discharge gas; and a back panel disposed to face the front panel with a discharge space interposed therebetween, and having phosphor layers to emit visible light from ultraviolet light generated by discharge of the discharge gas. The protective layer has a first protective layer on the side of the dielectric layer, and a second protective layer on the side of the discharge space. The first protective layer mainly contains MgO, and also contains any of Sc, Y, or Al, as well as Si. The second protective layer mainly contains MgO and also contains Si.

(2) In the plasma display panel described in paragraph (1), the first protective layer contains from 20 ppm to 5000 ppm Sc.

(3) In the plasma display panel described in paragraph (1), the first protective layer contains from 20 ppm to 1000 ppm Y.

(4) In the plasma display panel described in paragraph (1), the first protective layer contains from 20 ppm to 5000 ppm Al.

(5) There is provided a plasma display panel including: a front panel having plural electrodes, a dielectric layer on the electrodes, and a protective layer covering the dielectric layer; a discharge gas; and a back panel disposed to face the front panel with a discharge space interposed therebetween, and having phosphor layers to emit visible light from ultraviolet light generated by discharge of the discharge gas. The protective layer has a first protective layer on the side of the dielectric layer, and a second protective layer on the side of the discharge space. The first protective layer mainly contains MgO, and also contains any of Sc, Y, or Al, as well as H. The second protective layer mainly contains MgO and also contains H.

(6) There is provided a plasma display panel including: a front panel having plural electrodes, a dielectric layer on the electrodes, and a protective layer covering the dielectric layer; a discharge gas; and a back panel disposed to face the front panel with a discharge space interposed therebetween, and having phosphor layers to emit visible light from ultraviolet light generated by discharge of the discharge gas. The protective layer has a first protective layer for generating excitation light by the incidence of the ultraviolet light, and a second protective layer disposed on the side closer to the discharge space than the first protective layer, from which electrons are emitted to the discharge space.

(7) In the plasma display panel described in paragraph (6), the first protective layer has a shallow trap for capturing the electrons, and a recombination center in which the excitation light is generated by recombination of the electrons.

(8) In the plasma display panel described in paragraph (6) or (7), the second protective layer has an electron trap from which the electrons are emitted by the excitation light.

(9) In the plasma display panel described in any of paragraphs (1) to (8), the second protective layer has better sputtering resistance than the first protective layer.

(10) In the plasma display panel described in any of paragraphs (1) to (9), the secondary electron emission coefficient of the second protective layer is larger than the secondary electron emission coefficient of the first protective layer.

(11) In the plasma display panel described in any of paragraphs (1) to (10), the electric conductivity of the second protective layer is smaller than the electric conductivity of the first protective layer.

(12) In the plasma display panel described in any of paragraphs (1) to (11), the thickness of the second protective layer is more than 100 nm but not more than 1 μm.

(13) In the plasma display panel described in any of paragraphs (1) to (12), the concentration of Xe in the discharge gas is 8% or more.

(14) In the plasma display panel described in any of paragraphs (1) to (12), the concentration of Xe in the discharge gas is 12% or more.

The plasma display panel according to the present invention can achieve excellent priming-electron emission characteristics without deteriorating the characteristics of the protective layer, such as the sputtering resistance, secondary electron emission characteristics, and wall charge retention. Thus, the plasma display panel according to the present invention has advantages of high quality, long life, and less occurrence of erroneous display.

### BRIEF DESCRIPTION OF THE DRAWINGS

FIG. 1 is an exploded perspective view of a plasma display panel;

FIG. 2 is a cross-sectional view of different sections of a discharge cell;

FIGS. 3A to 3D are diagrams showing the cross-sectional structures of protective layers used as a sample of the present invention as well as comparative samples, and the measurement data of the discharge delay;

FIG. 4 is a diagram showing the driving waveforms for measuring the discharge delay;

FIGS. 5A, 5B are band diagrams according to the principle model of the present invention;

FIG. 6 is a cross-sectional view of the structure of a protective layer according to a first embodiment;

FIG. 7 is a block diagram of a protective layer deposition system according to the first embodiment;

FIGS. 8A to 8D are diagrams showing the cross-sectional structures of protective layers used as a sample of the first embodiment as well as comparative samples, and the measurement data of the discharge delay;

FIG. 9 is a cross-sectional view of the structure of a protective layer according to a second embodiment;

FIG. 10 is a block diagram of a protective layer deposition system according to the second embodiment; and

FIG. 11 is a cross-sectional view of the structure of a protective layer according to a third embodiment.

### DETAILED DESCRIPTION OF THE PREFERRED EMBODIMENTS

Hereinafter, the principle of the present invention will be described in detail with reference to the accompanying drawings showing an example of the experimental results from which the inventors have reached the present invention.

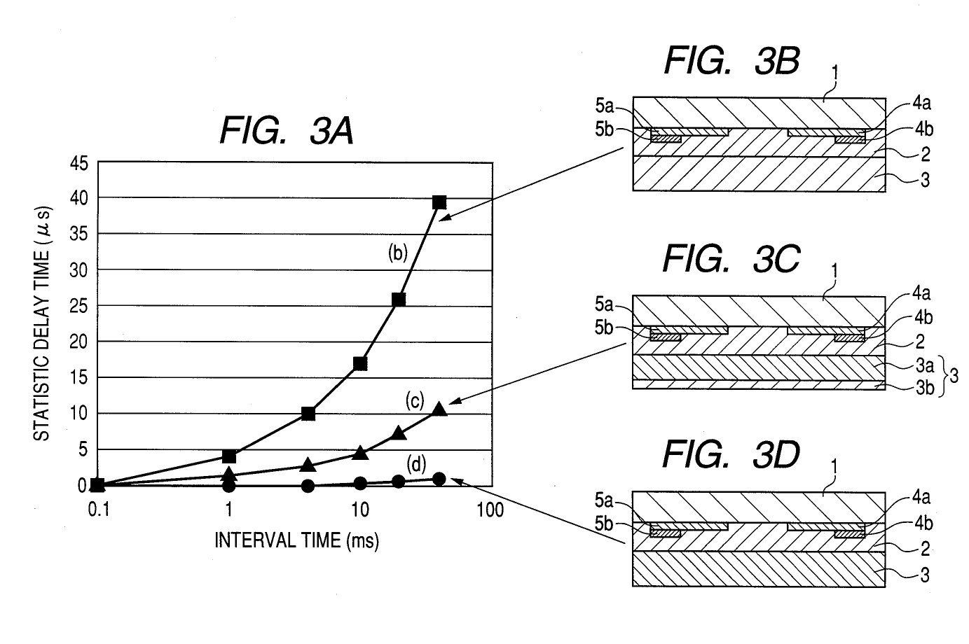

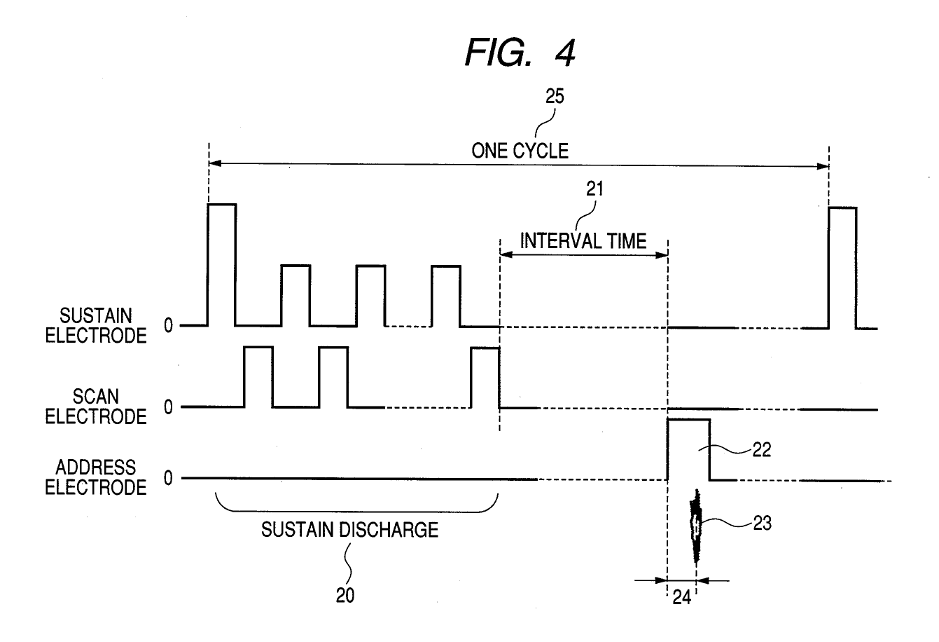

FIG. 3A is a graph showing an example of the results of the experiment conducted by the inventors. The graph shows the measurement results of address delay time. The address delay time is the time from when a predetermined address voltage is applied between the scan electrode 4 and the address electrode 10 to when discharge is started. More specifically, the address delay time includes the time from the voltage application to the priming electron emission as the starting point of the discharge (which is called as statistic delay time), as well as the time from the priming electron emission to the establishment of the discharge (which is called as formation delay time). In this experiment, the address discharge delay time was measured by connecting the scan electrode 4, the sustain electrode 5, and the address electrode 10 to a driving unit, based on the driving waveforms shown in FIG. 4. In this embodiment, the concentration of Xe gas is 12%.

First, a sustain discharge 20 is performed between the sustain electrode 5 and the scan electrode 4. After a fixed interval 21, an address voltage pulse 22 is applied to the address electrode. Then, an address delay time 24 from the application of the address voltage pulse 22 to the generation of address discharge 23 between the scan electrode 4 and the address electrode 10, is measured. The discharge generation time was measured by detecting infrared emission generated due to the discharge. The discharge delay phenomenon is a statistical phenomenon depending on the probability distribution indicating the likelihood that priming electrons will be generated. In this experiment, a one-cycle waveform 25 shown in FIG. 4 was repeated 1000 times for each measurement to obtain 1000 data on the discharge delay time.

FIG. 3A is a graph plotting the statistic delay time measured by the above method, versus the interval time. The ordinate represents the statistic delay time defined by the time interval from when the discharge occurs with a probability of 1% to when the discharge occurs with a probability of 90%, in the 1000 measurements of the discharge delay time. The discharge delay time directly relates to the priming electron emission probability. The abscissa represents the interval time from the last surface discharge before the address voltage is applied, until the address voltage is applied. The electrons in the protective layer are excited by ultraviolet light generated from the surface discharge. Then, the excited electrons are reduced with a certain time constant, and the priming electron emission probability is reduced. In other words, the longer the interval time the greater the discharge delay.

FIGS. 3B, 3C, and 3D are cross-sectional views showing the structures of protective layers used in the experiment, each showing the cross-sectional shape of a unit discharge cell in the vertical direction to the display electrode of the front panel. Each structure has the front substrate on which the scan electrodes 4a and 4b, the sustain electrodes 5a and 5b, and the dielectric layer 2 are formed, on which the protective layer 3 is formed. Here, in the case of the structure of FIG. 3B, the protective layer 3 is formed by growing MgO to a thickness of 700 nm. In the case of the structure of FIG. 3D, the protective layer 3 is formed by growing 250 ppm Sc-doped MgO to a thickness of 700 nm. In the case of the structure of FIG. 3C, a first protective layer 3a of 250 ppm Sc-doped MgO, which is similar to FIG. 3D, is grown to a thickness of 550 nm. Then, a second protective layer of undoped MgO, which is similar to FIG. 3B, is laminated on the first protective layer to a thickness of 150 nm.

In the graph of FIG. 3A, the discharge delay for the protective layer 3 of Sc-doped MgO, which is indicated by (d), is much more improved than the discharge delay for the case of undoped MgO indicated by (b). This could be related to the phenomenon that the electrons in MgO are excited by ultraviolet light generated in the discharge space, and that the electrons captured by the shallow trap due to Sc are gradually emitted by heat release. Also, the discharge delay in the two-layer structure (c) is more improved than the discharge delay in the structure using undoped MgO. In the case of the two-layer structure (c), the protective layer 3b exposed to the discharge space is formed from undoped MgO as similar to the structure (b), and the thickness of the protective layer 3b is 150 nm. Thus, it is difficult to believe that the priming electrons for improving the discharge delay are directly emitted from the Sc-doped protective layer 3a to the discharge space. Rather it is shown that the probability of priming electron emission from the undoped layer exposed to the discharge space, increases thanks to the Sc-doped layer disposed apart from the discharge space.

In order to study this phenomenon, the inventors have analyzed the energy level in the band gap by thermal luminescence and cathode luminescence, with respect to variously doped MgO samples. As a result, it has been clear from the thermal luminescence analysis that the Sc-doped MgO has an electron trap at a depth of about 0.62 eV from the conduction band. Also in the cathode luminescence analysis, an emission having a peak at about 310 nm was observed. As a result, it has been clear that the Sc-doped MgO has a recombination center to emit ultraviolet light with a wavelength of about 310 nm by recombination with electrons at an energy level of about 4.1 eV from the conduction band.

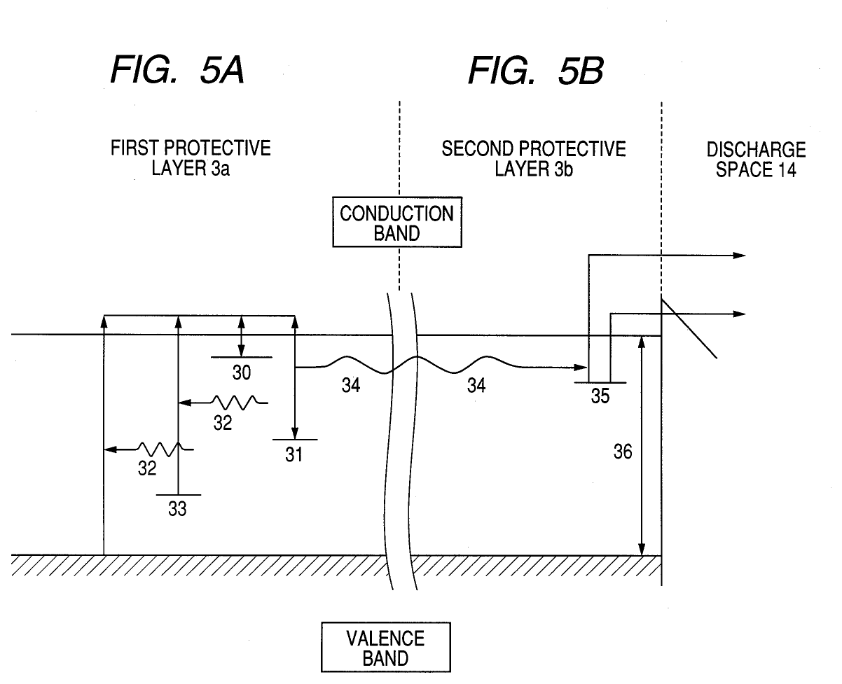

Based on the above results, a description will be given of the model considered to be the mechanism of discharge delay improvement in the protective layer having a two-layer structure as shown in FIG. 3C, with reference to the energy band diagrams of FIGS. 5A and 5B. FIGS. 5A and 5B show the model of energy bands, in which FIG. 5A is an energy band diagram of the first protective layer of Sc-doped MgO, and FIG. 5B is an energy band diagram of the second protective layer of undoped MgO. As described above, the first protective layer has a shallow trap 30 and a recombination center 31. Of ultraviolet light generated by the discharge in the discharge space, ultraviolet light 32 passing through the second protective layer 3b excites electrons including electrons in the valence band, electrons captured by the Sc-doped recombination center 31, and electrons captured by a level 33 due to oxygen defects that is known to exist at a depth of about 5 eV from the conduction band in MgO, to the conduction band.

Some of the excited electrons are captured by the shallow trap 30. The captured electrons are excited to the conduction band by thermal excitation, even when the output of the ultraviolet light 32 by the discharge is stopped. Then, some of the excited electrons are recombined with the recombination center 31 to generate excitation light 34. Part of the excitation light 34 is input to the second protective layer 3b, and excites the electrons captured by a shallow trap 35 in the second protective layer 3b in the area close to the discharge space 14. However, in the case of intentionally using undoped MgO, the trap is mainly due to hydrogen taken into the process. Then, the excited electrons are directly emitted to the discharge space 14 and Auger electrons are also emitted, thereby causing the priming electrons to be emitted. Incidentally, in FIGS. 5A and 5B, components (such as for example, the recombination center of the undoped MgO layer) other than those directly involved in the model described above, such as the trap level, are omitted for simplification.

While having described one model of the priming electron emission mechanism in the protective layer according to the present invention that the inventors developed, it is to be understood that the detailed mechanism of the present invention is not limited to the above model. The key of the plasma display panel according to the present invention resides in having the first protective layer for generating a predetermined excitation light, and the second protective layer for emitting electrons to the discharge space by the specific excitation light.

With this structure, it is possible to obtain the priming-electron emission characteristics, which have depended mostly on the characteristics of the area of the interfacial surface of the protective layer, through role sharing and accentuated effects of the first and second protective layers. As a result, it is possible to improve the discharge delay not only by the conventional priming electron emission from the second protective layer exposed to the discharge space, but also by the priming electron emission due to the contribution of the first protective layer. In addition, for example, when the characteristics of the first protective layer, such as sputter resistance, secondary electron emission characteristics, and wall charge retention are insufficient, the first protective layer is covered by the second protective layer having sputter resistance, secondary electron emission characteristics, and wall charge retention that are better than those of the first protective layer. This enables effects such as increasing the reliability, reducing the discharge voltage, and expanding the voltage margin.

While Sc-doped MgO has been used as an example in the above description, the effects can also be obtained when using Y or Al-doped MgO as the first protective layer according to the present invention. Particularly, it has been clear from the trap level analysis that Al-doped MgO has a shallow trap at a depth of about 0.58 eV from the conduction band, as well as a recombination center at a depth of about 5.3 eV from the conduction band. Thus, the Al-doped MgO is appropriate for the first protective layer according to the present invention.

The second protective layer according to the present invention may be formed from a material having optical characteristics so that at least part of ultraviolet light generated in the discharge space can reach the first protective layer to cause priming electron emission from the shallow trap. Here, Si or H-doped MgO is appropriate. For example, H-doped MgO is provided in such a way that MgO is deposited by electron beam evaporation in an H₂ atmosphere of about 2×10⁻² Pa.

In the protective layer according to the present invention, it is necessary that at least part of the ultraviolet light generated in the discharge space 14 reaches the first protective layer 3a through the second protective layer 3b. For this reason, it is preferable that the band gap 36 of the second protective layer is at least larger than the energy of the ultraviolet light generated by discharge in the discharge space 14. When a material mainly containing MgO is used for the protective layers 3a and 3b, the energy gap of the material is about 7.8 eV. The plasma display panel often uses mixture gas mainly containing Ne and Xe as the discharge gas. The energy distribution of the ultraviolet light generated by discharge of the discharge gas, varies depending on the composition of the discharge gas. It is known that the higher the partial pressure of Xe, the greater the proportion of the ultraviolet light with an emission wavelength of 173 nm relative to the ultraviolet light with an emission wavelength of 147 nm. In the plasma display panel according to the present invention, the ultraviolet light effectively reaches the first protective layer, with a higher proportion of the ultraviolet light of 173 nm wavelength that corresponds to an emission with energy lower than the band gap energy of MgO. For this reason, the partial pressure of Xe is preferably higher, and in particular, the partial pressure of Xe is preferably 8% or more in the composition ratio.

Incidentally, the thickness of the second protective layer is preferably more than 100 nm but not more than 1 μm. This is because the first protective layer is not exposed when the second protective layer is sputtered to a certain depth by ion bombardment from the discharge, the excitation light generated in the first protective layer effectively reaches the area of the interfacial surface of the second protective layer, and the discharge voltage is not increased.

Hereinafter, embodiments of the present invention will be described in detail with reference to the accompanying drawings. Throughout all the drawings for explaining the embodiments, the components having identical functions will be designated by the common reference numerals, and their repeated description will be omitted.

### First Embodiment

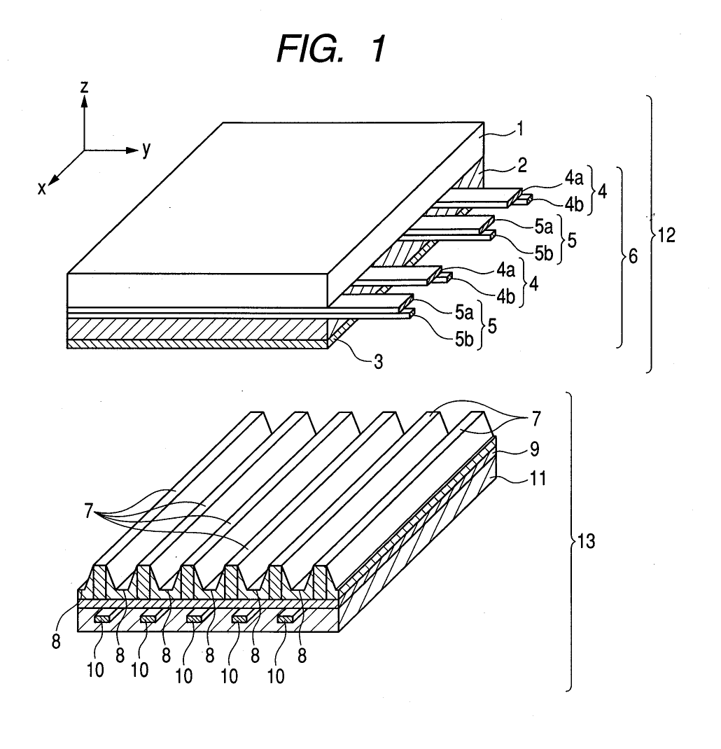

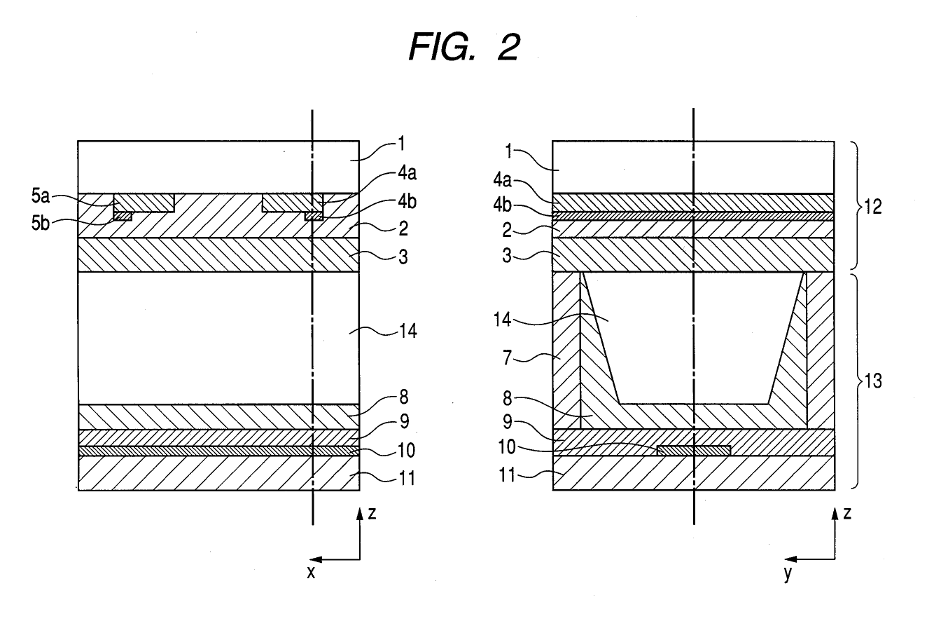

The basic structure of the plasma display panel according to the present invention is the same as the structure shown in FIGS. 1 and 2, except for the protective layer 3. First, a method for forming the front panel 12 will be described. The display electrode 6 having stripe-like transparent electrodes 4a, 5a and bus electrodes 4b, 5b, is provided on the front substrate 1. The display electrode 6 is a pair of scan electrode 4 and sustaining electrode 5. The transparent electrodes 4a, 5a are formed from a film of indium tin oxide (ITO) which is a transparent conductor. The bus electrodes 4b, 5b are formed from a single-layer film of silver with a narrower width than the transparent electrodes 4a, 5a. The bus electrodes 4b, 5b are formed on the transparent electrodes 4a, 5a, respectively.

Incidentally, the transparent electrodes 4a, 5a may also be formed from tin oxide, zinc oxide, and the like. Similarly, the bus electrodes 4b, 5b may also be formed from a single-layer film of aluminum, or a laminated film of chrome/copper/chrome, and the like. The transparent electrodes 4a, 5a and bus electrodes 4b, 5b of the display electrode 6 are covered by the dielectric layer 2. The dielectric layer 2 is formed from a dielectric glass film having transparency to visible light. Then, the protective layer 3 is formed on a surface of the dielectric layer 2. The structure and method for forming the protective layer 3, which is the feature of the present invention, will be described in detail later.

Next, a method for forming the back panel 13 will be described. The stripe-like address electrodes 10 are provided on the back substrate 11. The address electrodes 10 are covered by the dielectric layer 9, on which the barrier ribs 7 are formed to maintain discharge gaps and prevent cross talk between adjacent cells. The barrier ribs 7 are arranged parallel to the address electrodes 10. In other words, the address electrodes 10 are respectively provided between the barrier ribs 7. The phosphor layers 8 are formed respectively between the barrier ribs 7 to emit red light, green light, and blue light.

Next, the front panel 12 and the back panel 13 are disposed facing each other so that the display electrodes 6 and the address electrodes 10 are orthogonal to each other. Then, non-display areas of the two panels are sealed with a sealing agent to form the discharge space 14 which is isolated from the outside air. The discharge space 14 is filled with mixture gas mainly containing neon (Ne)-xenon (Xe), as the discharge gas at a predetermined pressure and partial pressure. In this embodiment, the partial pressure of Xe is 20%.

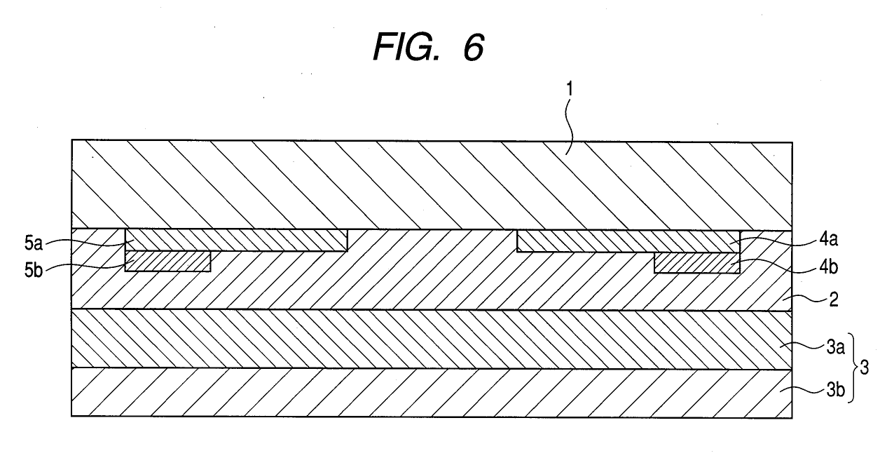

The structure of the protective layer according to the present invention will be described in detail with reference to FIG. 6. FIG. 6 is a view showing the cross-sectional shape of a unit discharge cell in the vertical direction to the display electrode of the front panel. The transparent electrodes 4a, 5a and bus electrodes 4b, 5b of the display electrode, as well as the dielectric layer 2 covering these electrodes, are formed on the front substrate 1. Then, the protective layer 3 is formed on the dielectric layer 2. Here, the protective layer 3 includes the first protective layer 3a (400 nm thick) and the second protective layer 3b (300 nm thick), both mainly containing MgO. The second protective layer 3b is doped with 300 ppm Si. The first protective layer 3a is doped with 250 ppm Sc, in addition to the composition of the second protective layer. The effects begin to appear when the amount of Sc is 20 ppm. On the other hand, there is a problem that the conductivity of the electro-conductive layer is too high when the amount of Sc exceeds 5000 ppm. Thus, the amount of Sc is preferably between 20 ppm and 5000 ppm.

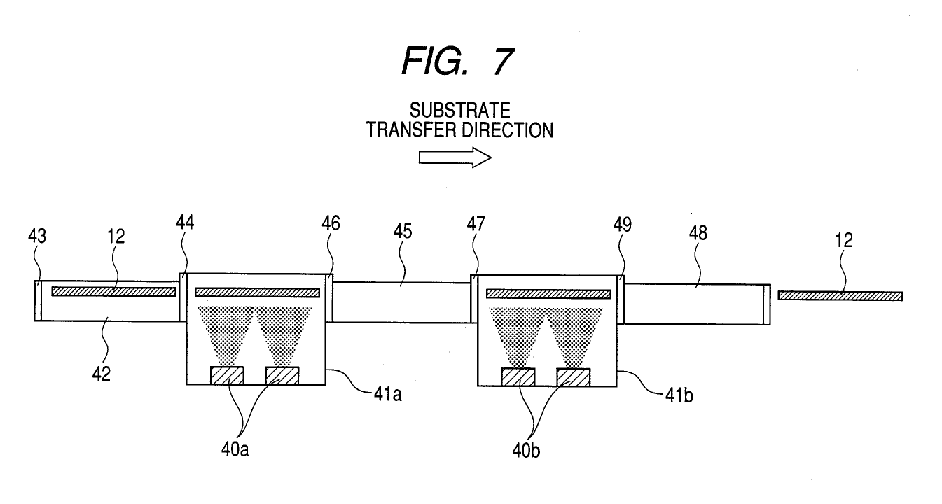

Next, a method for forming the protective layer 3 of this embodiment will be described in detail with reference to FIG. 7. The protective layer according to the present embodiment is formed by electron beam evaporation using a vacuum deposition system having two vapor deposition chambers 41a, 41b that are respectively provided with evaporation sources 40a, 40b. First, the front panel 12 on which the display electrodes 6 and the dielectric layer 2 are formed, is mounted to a given holder so that the surface of the front panel 12, on which the dielectric layer 2 is formed, faces the evaporation sources 40a, 40b. Then, the front panel 12 is horizontally disposed in a preparation chamber 42. Next, a divider 43 is closed to exhaust the preparation chamber 42 by a vacuum pump to a vacuum state of 1×10⁻³ Pa or less. The front panel 12 is heated by a heater to a temperature of about 250° C. to remove moisture or other contaminants absorbed by the surface.

Next, a divider 44 between the preparation chamber 42 and a first vapor deposition chamber 41a is opened. Then, the front panel 12 is introduced into the first vapor deposition chamber 41a, while maintaining the temperature of the front panel 12 and the vacuum state. After introduction of the front panel 12, the divider 44 between the preparation chamber 42 and the first vapor deposition chamber 41a is closed. In the evaporation source 40a of the first vapor deposition chamber 41a, there is provided a water-cooled hearth filled with an evaporation material. The evaporation material is irradiated by thermoelectrons from an electron gun, and thus heated and evaporated. Here, the hearth of the first vapor deposition chamber 41a is filled with evaporation pellets of MgO containing Si and Sc, which is the material of the first protective layer 3a according to the present embodiment. The deposition is performed such that the evaporation material is heated and evaporated by irradiation of thermoelectrons, which is then deposited onto the dielectric layer 2. During the deposition in the first vapor deposition chamber 41a, the surface temperature of the front panel 12 and the dielectric layer 2 is maintained between 200° C. and 300° C. At the same time, the inside pressure is adjusted to about 1×10⁻² Pa by introducing oxygen gas. In this way, the first protective layer 3a was deposited to a thickness of 400 nm.

Next, a divider 46 between the first vapor deposition chamber 41a and a transfer chamber 45 is opened to move the front panel 12 into the transfer chamber 45. After that, the divider 46 is closed, and a divider 47 between the transfer chamber 45 and a second vapor deposition chamber 41b is opened. Then, the front panel 12 is introduced into the second vapor deposition chamber 41b. The second vapor deposition chamber 41b has basically the same structure as the first vapor deposition chamber 41a, except that a hearth of the evaporation source 40b is filled with evaporation source pellets of MgO containing Si, which is the material of the second protective layer 3b. The second protective layer 3b is deposited on the first protective layer 3a to a thickness of 300 nm, under the same conditions as the first protective layer 3a.

After deposition, the front panel 12 is introduced into a cooling chamber 48, and a divider 49 between the second vapor deposition chamber 41b and the cooling chamber 48 is closed. Then, the front panel 12 is cooled to room temperature. The inside pressure is restored to atmospheric pressure from the vacuum state, by introducing inert gas or other gas into the cooling chamber 48. When the pressure in the cooling chamber 48 is atmospheric pressure, the front panel 12 is taken out of the cooling chamber 48.

Although in this embodiment MgO for forming the protective layer 3 is deposited by electron beam evaporation, other deposition methods can also be used, such as ion assisted deposition, sputtering, and chemical vapor deposition (CVD).

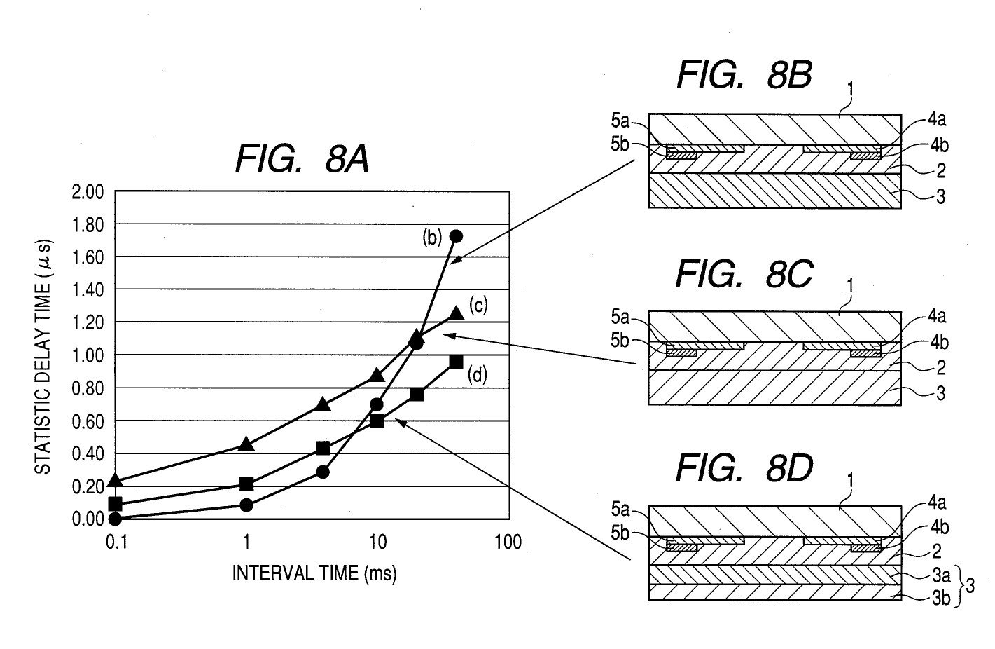

FIG. 8A is a graph showing measurement results of address discharge delay time in the plasma display panel according to the present embodiment. The measurement procedure is the same as in the experiment whose results are shown in FIG. 3A. Here, in the actual operation of the plasma display panel, the amount of ultraviolet light incident to the protective layer from the discharge space before application of address voltage, as well as the interval time from the incidence of light to the application of address voltage, vary depending on the display pattern and driving method. In order to prevent erroneous display under wide conditions including conditions after an erroneous display in which the interval time generally increases, the discharge delay is preferably suppressed to a low value for a longer interval time.

FIGS. 8B, 8C, and 8D are cross-sectional views of the structures of protective layers. FIG. 8D shows the structure of the first embodiment according to the present invention shown in FIG. 6. In this structure, the first protective layer 3a (400 nm thick) is formed from MgO doped with 300 ppm Si and 500 ppm Sc, on which the second protective layer 3b (300 nm thick) of MgO doped with 300 ppm Si is formed. FIGS. 8B and 8C show the structures of different protective layers prepared for comparison. FIG. 8B shows the structure in which MgO, which is doped with 300 ppm Si and 500 ppm Sc as similar to the structure of the first protective layer 3a, is grown to a thickness of 700 nm. FIG. 8C shows the structure in which MgO, which is doped with 300 ppm Si as similar to the structure of the second protective layer 3b, is grown to a thickness of 700 nm. The thicknesses of the protective layers 3 of (b), (c), (d), are substantially equal to each other.

First comparing, in FIG. 8A, the structures (b) and (c) of the protective layers 3 each having a single-layer structure. In the short interval time region, the discharge delay in the structure of FIG. 8B is smaller than the discharge delay in the structure of FIG. 8C. This shows that the amount of priming electrons emitted for a short time is greater in the case of co-doping of Sc than in the case of single doping of Si. However, the two curves cross each other as the interval time increases. In other words, the discharge delay in the structure (b) is larger than the discharge delay in the structure (c). This shows that in the Si and Sc co-doped structure (b), the amount of priming electrons emitted due to Si after a long interval time is smaller than in the single Si-doped structure (c), although the structure (b) is doped with 300 ppm Si which is the same amount as the structure (c). This can be explained by the fact that in the capture process of electrons generated by the ultraviolet light incident from the discharge space, the electron traps of Sc and Si compete with each other, resulting in a reduction of the amount of captured electrons relative to Si that emits electrons for a longer interval time.

On the other hand, in the structure of FIG. 8D according to the present invention, there is no competition between the electron traps in the surface layer, so that the discharge delay is improved over the whole interval time, compared to the case of the single Si-doped structure. As described above, in this embodiment, Sc is doped to the protective layer except for the area of the interfacial surface that directly emits priming electrons. As a result, the discharge delay is improved over the whole interval time, without impairing the effects of Si in the longer interval time region. This enables prevention of erroneous display occurring in the plasma display panel.

Incidentally, the temperature dependency of the priming electron emission is different between Si and Sc. The priming electron emission due to Sc is more likely to occur during short interval time at high temperature. Because the structure of this embodiment is designed to improve the discharge delay without influence on the electron capture by the trap due to Si in the area of the interfacial surface of the protective layer, it is more advantageous than the co-doped single layer structure.

### Second Embodiment

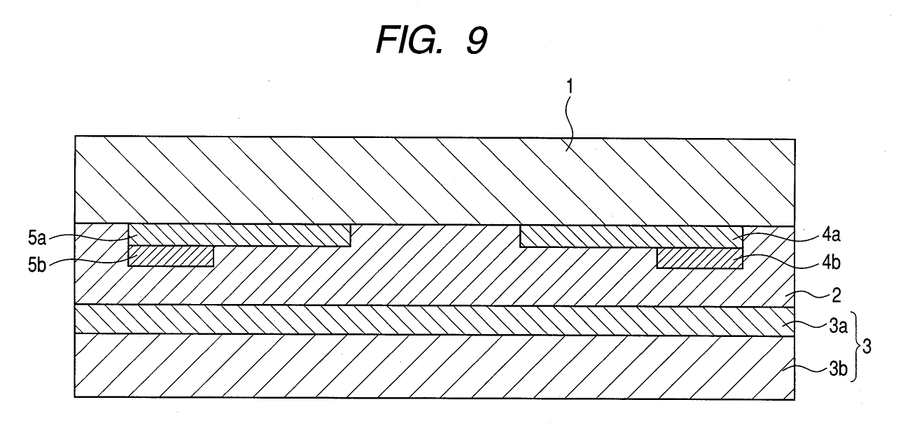

This embodiment has the same structure and process as the first embodiment, except for the structure and deposition system of the protective layer 3. The concentration of Xe in this embodiment is 8%. FIG. 9 shows the structure of the protective layer 3 according to the present embodiment. Similarly to the first embodiment, the protective layer 3 of this embodiment has first and second protective layers 3a, 3b mainly containing MgO. The difference is that in this embodiment, the first protective layer 3a (200 nm thick) is doped with 1000 ppm Y, and the second protective layer 3b (400 nm thick) is doped with 500 ppm Si and 500 ppm Ca. The effect of Y appears starting at a concentration of about 20 ppm, up to about 1000 ppm. According to the experiment, doping of Y is relatively difficult, and is limited to a concentration of about 1000 ppm for practical purposes.

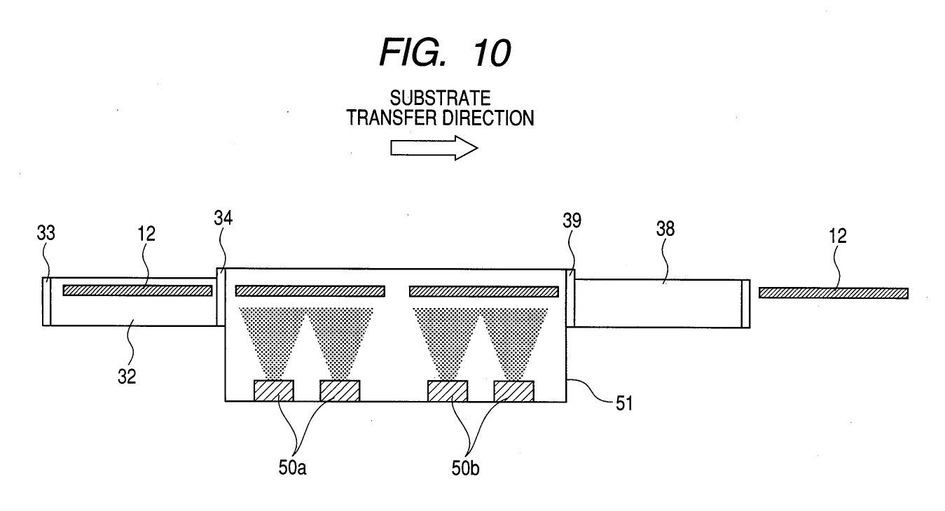

Next, the method for forming the protective layer 3 of this embodiment will be described in detail with reference to FIG. 10. The protective layer according to the present embodiment is formed by a single vapor deposition chamber 51 having evaporation sources 50a, 50b for depositing different evaporation materials. The evaporation materials are deposited by moving the front panel 12 in the vapor deposition chamber 51, to continuously form the first and second protective layers 3a, 3b. The hearth of the first evaporation source 50a is filled with evaporation source pellets of MgO containing Y, which is the material of the first protective layer 3a of this embodiment. The hearth of the second evaporation source 50b is filled with evaporation source pellets of MgO containing Si and Ca, which is the material of the second protective layer 3b. Under the same conditions as the first embodiment, the first protective layer is deposited to a thickness of 200 nm, followed by the second protective layer deposited to a thickness of 400 nm in a continuous manner.

In this embodiment, the deposition system continuously forms the first and second protective layers 3a, 3b in the single vapor deposition chamber 41 by the method described above. Another possible method is, for example, that the evaporation materials of different compositions are filled in different places within the hearth to switch the evaporation materials by moving the hearth and/or the electron beam.

In the first protective layer 3a of this embodiment, Y doped into MgO also has a function to generate excitation light to cause priming electron emission from the surface of the second protective layer 3b. However, when the area exposed to the discharge space is co-doped with Y, and even with 500 ppm Y, the sputtering resistance was found to be more deteriorated than the case of non-doping of Y. In this embodiment, the protective layer 3 is formed such that Y is doped into the first protective layer 3a except for the surface layer thereof. As a result, the obtained protective layer has no influence on the sputtering resistance even with a doping of 1000 ppm Y, a smaller discharge delay than the case of non-doping of Y, and a longer lifetime than the case of co-doping of Y into the whole layer.

### Third Embodiment

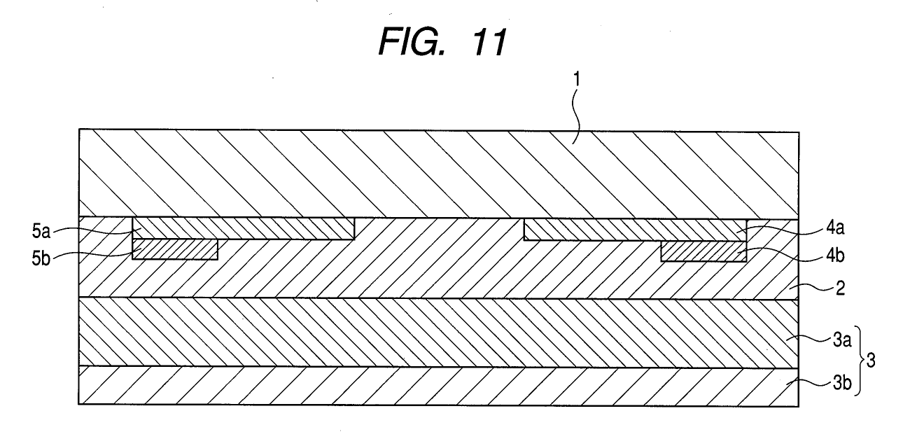

This embodiment has the same structure and process as the first and second embodiments, except for the structure and deposition method of the protective layer. The concentration of Xe in this embodiment is 8%. The structure of the protective layer according to the present embodiment will be described with reference to FIG. 11. The protective layer 3 of this embodiment includes two layers, a first protective layer 3a (500 nm thick) and a second protective layer 3b (300 nm thick), both mainly containing MgO. The first protective layer 3a is doped with 1000 ppm Al, and the second protective layer 3b is doped with 600 ppm Si. The effect of Al appears starting at a concentration of 20 ppm. On the other hand, there is a problem that the conductivity of the first protective layer 3a is too high when the amount of Al exceeds 5000 ppm. Thus, the amount of Al is preferably between 20 ppm and 5000 ppm.

The protective layer 3 of this embodiment is formed by an electron beam evaporation system having two vapor deposition chambers 41a and 41b, similarly to the first embodiment shown in FIG. 7. The third embodiment is different from the first embodiment in that the deposition conditions vary between the vapor deposition chambers 41a and 41b. In the third embodiment, the first protective layer 3a is formed in the vapor deposition chamber 41a in which the partial pressure of oxygen and the substrate temperature are different from those in the first embodiment. The second protective layer 3b is formed in the vapor deposition chamber 41b under the same conditions as the first embodiment.

The first protective layer 3a of this embodiment has different crystalline characteristics from those of MgO deposited under normal conditions, and has lower sputtering resistance. At the same time, the first protective layer 3a of this embodiment has characteristics that the time-dependent degradation of the discharge delay reduction effect is small. In this embodiment, the first protective layer 3a of Al-doped MgO having different crystalline characteristics, is not exposed to the discharge space, but is covered by the second protective layer 3b having excellent sputtering resistance. This enables the effects of increasing the discharge delay time and the time-dependent degradation of the discharge delay time, while maintaining the resistance against ion sputtering.

In the embodiments described in detail above, no specific concentration gradient is formed for each of the impurity concentrations of the first and second protective layers 3a, 3b. However, it is also possible that the impurity concentration continuously changes from the first protective layer 3a to the second protective layer 3b, by forming a concentration gradient in the film thickness direction and by a sequential deposition technique. Also, it is to be understood that the protective layer according to the present invention is not necessarily limited to the two-layer structure, but may be a three or more layer structure.

What is claimed is:

1. A plasma display panel comprising:
a front panel having a plurality of electrodes, a dielectric layer on the electrodes, and a protective layer covering the dielectric layer;
a discharge gas; and
a back panel disposed to face the front panel with a discharge space interposed therebetween, and having phosphor layers to emit visible light from ultraviolet light generated by discharge of the discharge gas,
wherein the protective layer has a first protective layer on the side of the dielectric layer, and a second protective layer on the side of the discharge space, and
wherein the first protective layer mainly contains MgO, and also contains any of Sc, Y, or Al, and the second protective layer mainly contains MgO and also contains Si.

2. The plasma display panel according to claim 1, wherein the first protective layer contains from 20 ppm to 5000 ppm Sc.

3. The plasma display panel according to claim 1, wherein the first protective layer contains from 20 ppm to 1000 ppm Y.

4. The plasma display panel according to claim 1, wherein the first protective layer contains from 20 ppm to 5000 ppm Al.

5. A plasma display panel comprising:
a front panel having a plurality of electrodes, a dielectric layer on the electrodes, and a protective layer covering the dielectric layer;
a discharge gas; and
a back panel disposed to face the front panel with a discharge space interposed therebetween, and having phosphor layers to emit visible light from ultraviolet light generated by discharge of the discharge gas,
wherein the protective layer has a first protective layer on the side of the dielectric layer, and a second protective layer on the side of the discharge space, and
wherein the first protective layer mainly contains MgO and also contains any of Sc, Y, or Al, as well as H, and the second protective layer mainly contains MgO and also contains H.

6. A plasma display panel comprising:
a front panel having a plurality of electrodes, a dielectric layer on the electrodes, and a protective layer covering the dielectric layer;
a discharge gas; and
a back panel disposed to face the front panel with a discharge space interposed therebetween, and having phosphor layers to emit visible light from ultraviolet light generated by discharge of the discharge gas,
wherein the protective layer has a first protective layer for generating excitation light by the incidence of the ultraviolet light, and a second protective layer disposed on the side closer to the discharge space than the first protective layer, from which electrons are emitted to the discharge space.

7. The plasma display panel according to claim 6,
wherein the first protective layer has a shallow trap for capturing electrons, and a recombination center in which the excitation light is generated by recombination of the electrons.

8. The plasma display panel according to claim 6,
wherein the second protective layer has an electron trap from which the electrons are emitted by the excitation light.

9. The plasma display panel according to claim 1,
wherein the second protective layer has better sputtering resistance than the first protective layer.

10. The plasma display panel according to claim 1,
wherein the secondary electron emission coefficient of the second protective layer is larger than the secondary electron emission coefficient of the first protective layer.

11. The plasma display panel according to claim 1,
wherein the electric conductivity of the second protective layer is smaller than the electric conductivity of the first protective layer.

12. The plasma display panel according to claim 1,
wherein the thickness of the second protective layer is more than 100 nm but not more than 1 μm.

13. The plasma display panel according to claim 1,
wherein the concentration of Xe in the discharge gas is 8% or more.

14. The plasma display panel according to claim 1,
wherein the concentration of Xe in the discharge gas is 12% or more.
